(19) United States
(12) Patent Application Publication
(10) Pub. No.: US 2012/0152928 A1
(43) Pub. Date: Jun. 21, 2012

(54) Auxiliary Material for Soldering Sheets

(76) Inventor: Eberhard Schmid, Alzenau i.UFr. (DE)

(21) Appl. No.: 13/380,700

(22) PCT Filed: Jul. 5, 2010
(86) PCT No.: PCT/EP10/59552

§ 371 Date: Mar. 9, 2012

(30) Foreign Application Priority Data
Jul. 8, 2009 (DE) 10 2009 032 371.6

(51) Int. Cl. B23K 35/30; C22C 30/02

(52) U.S. Cl. 219/146.23; 420/587

(57) ABSTRACT

The invention relates to an auxiliary material for soldering steel sheets, wherein the auxiliary material comprises weight percentages of 15 to 40% Zn, 5 to 30% Mn, 0.01 to 10% Ni, and typical impurities no greater than 1%, and the remainder Cu.

The present invention relates to an auxiliary material for soldering sheets having the features of Claim 1.

Auxiliary materials of the type mentioned in the introduction are used in particular in the automotive industry, where they are used for joining parts of the vehicle body having thin walls. When joining thin-walled automotive body sheets, which are usually to be coated with zinc, it is important in particular to minimize the heat input required for joining, so that the sheets to be joined together may be joined with the least possible distortion, on the one hand, while on the other hand, the zinc coating of these sheets is damaged as little as possible in the joining operation and thus a joint seam having the least possible corrosion susceptibility is made possible.

Based on the fact that the melting point of the known auxiliary materials containing copper is usually higher than 1000° C., high temperatures for performing the joining operation are required accordingly. Firstly, these high temperatures lead to evaporation of the zinc coating of the automotive body sheets in the area of the joined connection and, secondly, thermal stresses in the sheets that have been cut to size and are to be joined together are produced due to the high temperatures, so this necessitates applying corresponding restraining forces in order to prevent deformation of the cut sheet blanks, which would otherwise lead to distortion of the cut sheets and/or irregular gap development of the joining gap, which is defined by the joining edges of the sheet metal blanks.

From the disadvantages that are known in the state of the art, it is clear that there is a demand for a copper-containing auxiliary material, which will make it possible to conduct joining operations on thin-walled sheet metal even at a comparatively low joining temperature to avoid the known disadvantages, so that evaporation of the zinc coating is prevented or at least reduced on the one hand, while on the other hand, a reduction in the distortion forces which occur in the joining operation is possible, which allows even comparatively low forces to be sufficient for securing the sheet metal blanks that are to be joined together.

The object of the present invention is therefore to propose a copper-containing auxiliary material, which has a comparatively low melting point.

This object is achieved by an auxiliary material having the features of Claim 1.

According to the invention, the auxiliary material contains, in percent by weight, 15 to 40% Zn, 5 to 30% Mn, 0.01 to 10% Ni, no more than 1% of the usual impurities and Cu as the remainder.

The comparatively high zinc content in conjunction with the other alloy constituents in particular is responsible for the fact that the auxiliary material according to the invention, which is corrosion-resistant in particular, can be used not only for welding in the gas-metal-arc (GMA) method or laser soldering or in particular in the metal-inert-gas (MIG) method of soldering stainless steel sheet metal, but is most especially suitable for joining thin sheet metal having sheet thicknesses of possibly less than 1.5 mm because of its relatively low melting point, which may be significantly lower than 900° C., depending on the composition of the alloy within the specified range limits.

The suitability for joining thin metal sheets by soldering is attributable in particular to the low energy demand because of the low melting point. The energy input, which can thus be reduced accordingly, ultimately leads to less deformation of the metal sheets.

Because of the low risk of deformation, the auxiliary material according to the invention is also suitable in particular for joining sheet metal of different thicknesses, as is the case in the transition between the body and the chassis of a vehicle, for example.

The low melting point makes the auxiliary material according to the invention especially suitable for joining galvanized sheet metal, because a much lower rate of evaporation of the zinc coating can be achieved at the evaporation temperature of zinc of 911° C. in comparison with using the known auxiliary materials.

In addition, most auxiliary material is characterized by good flow and wetting properties as well as good bridging of gaps because of the alloy according to the invention containing Zn, Mn and Ni, so as a result this ensures a tight stable seam. The high surface tension of the molten auxiliary material also contributes in particular toward achieving good bridging of gaps, which can be attributed in particular to the Mn content of the alloy in combination with the low melting point.

Furthermore, the comparatively high zinc content is responsible for the fact that the auxiliary material according to the invention has very good cold-forming properties, so that a welding wire or soldering wire manufactured from the auxiliary material according to the invention can be manufactured inexpensively even with a diameter of 0.8 mm or less.

Based on the good wetting behavior and the grayish color of the auxiliary material, which results from the alloy composition, its appearance resembles a sheet metal surface, so that the auxiliary material is especially suitable for use in the outer skin area of an automotive body. Thus an outer skin comprised of different sheet metal blanks has a one-piece appearance despite the soldered seams.

Furthermore, comparatively high joining speeds are possible at a relatively low energy demand because of the good flow and wetting performance.

In a preferred embodiment, the auxiliary material contains 20 to 25 wt % Zn, 8 to 13 wt % Mn and 0.2 to 1.2% Ni. Because of the relatively high manganese content in particular, this embodiment is suitable for joining highly alloyed stainless metal sheets.

It has been found that an alloy of the auxiliary material containing 22 wt % Zn, 10 wt % Mn and 0.5 wt % Ni can be used especially universally for the stated alloy ingredients, regardless of the actual composition of the highly alloyed sheets to be joined in the given case, in particular while maintaining the respective tolerance range of ±10%.

According to another preferred embodiment, if the auxiliary material contains 27 to 33 wt % Zn, 15 to 25 wt % Mn and 2 to 6 wt % Ni, then this auxiliary material is especially suitable for joining high-strength sheets because the strength increases due to the elevated Ni content. An increase in Mn content is associated with an increased toughness of the material, so that the production of falling seams in particular is facilitated.

Regardless of the actual given composition of the high-strength sheets to be joined, it has been found that an auxiliary material containing 30 wt % Zn, 20 wt % Mn and 4 wt % Ni can be used universally, in particular in a tolerance range of ±10%.

To be able to largely rule out an influence of the usual impurities on the advantageous properties of the auxiliary material, the usual impurities should not include more than 0.2 wt % Al and Sn and no more than 0.1 wt % Mg, Cr and Co.

An auxiliary material containing component 0.01 to 4 wt % Fe as the additional has proven to be especially advantageous with regard to the strength as well as easier wetting on steel materials. Addition of 0.01 to 0.5 wt % Si has also had the effect of increasing the strength.

The advantageous effects that can be achieved above when using the auxiliary material for joining, which are attributable in particular to the low melting point of the auxiliary material, can be further increased by using the auxiliary material to perform a soldering or welding method using a beam/radiation source as the heat input device. Since a very discrete heat input is possible by using a beam source, it is possible to ensure that the joining temperature, which is relatively low anyway, is limited to a narrow local range, further minimizing the risk of deformation of the sheet metal blanks in joining and/or at a high rate of evaporation of a zinc coating applied to the sheet metal blanks. The auxiliary material according to the invention is suitable in particular for use in an electric arc method, in both continuous operation and in pulsed operation.

1. An auxiliary material for soldering sheet metal, the auxiliary material comprising in wt %;
15% to 40% Zn;
5% to 30% Mn;
0.01% to 10% Ni;
no more than 1% impurities; and
the remainder being Cu.

2. The auxiliary material according to claim 1, which the auxiliary material includes 20% to 25% Zn, 8% to 13% Mn, and 0.2% to 1.2% Ni.

3. The auxiliary material according to claim 2, which the auxiliary material includes 22% Zn, 10% Mn, and 0.5% Ni.

4. The auxiliary material according to claim 1, which the auxiliary material includes 27% to 33% Zn, 15% to 25% Mn, and 2% to 6% Ni.

5. The auxiliary material according to claim 4, which the auxiliary material includes 30% Zn, 20% Mn, and 4% Ni.

6. The auxiliary material according to claim 1, in which the impurities include in wt % Al<0.2%, Sn<0.2%, Mg<0.1%, Cr<0.1%, and Co<0.1%.

7. The auxiliary material according to claim 1, in which the auxiliary material includes 0.01% to 4 wt % Fe.

8. The auxiliary material according to claim 1, in which the auxiliary material includes 0.01% to 0.05 wt % Si.

9. A method of using an auxiliary material, said method comprising:
providing an auxiliary material according to claim 1; and
performing at least one of a soldering method and a welding method on the auxiliary material with a beam source as a heat input device.
